(19) United States
(12) Patent Application Publication
(10) Pub. No.: US 2026/0171452 A1
(43) Pub. Date: Jun. 18, 2026

(54) ELECTROLYTES AND METHODS OF USING AND MAKING THE SAME

(71) Applicant: UNIVERSITY OF CONNECTICUT, Farmington, CT (US)

(72) Inventors: Xiao-Dong Zhou, Columbia, CT (US); Nengneng Xu, Vernon, CT (US); Yudong Wang, Willimantic, CT (US); Zizhou He, Willimantic, CT (US)

(21) Appl. No.: 19/425,348

(22) Filed: Dec. 18, 2025

Related U.S. Application Data
(60) Provisional application No. 63/735,429, filed on Dec. 18, 2024.

(51) Int. Cl. H01M 8/1253; C25B 9/70; C25B 13/07; H01M 8/12; H01M 8/126; H01M 8/2425

(52) U.S. Cl. CPC H01M 8/1253; C25B 9/70; C25B 13/07; H01M 8/126; H01M 8/2425; H01M 2008/1293

(57) ABSTRACT

The present teachings describe ceramic electrolytes for use as proton conductors. The present teachings also describe methods of making and using the electrolytes.

### CROSS REFERENCE TO RELATED APPLICATION

This application claims priority to U.S. Patent Application No. 63/735,429, filed Dec. 18, 2024, the contents of which are incorporated by reference in their entirety herein.

### STATEMENT REGARDING FEDERALLY SPONSORED RESEARCH

This invention was made with government support under DE-AR0001774 awarded by the U.S. Department of Energy. The government has certain rights in the invention.

### BACKGROUND OF THE INVENTION

### 1. Field of the Invention

The invention disclosed herein relates to electrolytes for energy storage, and in particular to proton conductors.

### 2. Description of the Related Art

Proton conductors are materials that facilitate the movement of protons (H⁺ ions) through their structure, playing a valuable role in technologies like fuel cells, sensors, and electrochemical devices. Their fabrication often begins with specific precursor materials that are processed to form the final proton-conducting phase.

Types of precursors include polymers, such as perfluorosulfonic acid polymers, common examples include Nafion, which contains a fluoropolymer backbone and sulfonic acid groups; aromatic polymers, examples include polybenzimidazole (PBI) doped with acids like phosphoric acid for high-temperature applications; inorganic materials; oxides and phosphates: proton-conducting ceramics such as barium zirconate (BaZrO₃), doped with elements like yttrium (Y) to enhance conductivity; hydrated materials, examples include phosphoric acid and other hydrated phases that enable proton transport via hydrogen bonding networks; hybrid organic-inorganic materials; metal-organic frameworks (MOFs), these materials combine metal ions or clusters with organic linkers, facilitating proton transport through embedded acidic functional groups.

Processing the precursors can be performed using various techniques. These include, for example: chemical doping, which calls for introducing acidic or basic groups into the material to enhance proton conductivity; thermal treatment which calls for optimizing the crystal structure to support proton migration; and sol-gel processing, which is a method to create thin films or highly porous structures with tailored compositions.

Fabrication methods can include using polymer-based proton conductors; solution vesting, which calls for dissolving polymer precursors in solvents, followed by casting and evaporation to form membranes; electrospinning, which calls for creating fibrous mats with nanoscale porosity for high proton conductivity; cross-linking, which calls for chemically bonding polymer chains to enhance mechanical and thermal stability. Using inorganic and ceramic proton conductors can be performed, and can involve solid-state synthesis, such as mixing precursor powders, followed by calcination to form a desired phase; sintering by compacting and heating powders to create dense ceramic components; and thin film deposition techniques like sputtering or chemical vapor deposition to create thin, dense layers for applications in micro-devices. Fabrication can also involve use of composite proton conductors, for example, by combining organic and inorganic phases for enhanced performance. These composites are often fabricated through co-casting, such as by simultaneously processing the organic and inorganic phases; and infiltration, such as by filling porous structures (e.g., ceramics) with a proton-conductive polymer or electrolyte.

Key proton transport mechanisms for consideration during fabrication can include: vehicle mechanisms, where protons are transported with the assistance of molecules like water or phosphoric acid; and the Grotthuss mechanism, where protons “hop” between neighboring sites, facilitated by hydrogen bonds and the operational environment. That is, temperature, humidity, and chemical stability must align with the intended application. Integration of the fabricated proton conductor must be compatible with other components, such as electrodes in fuel cells, ensuring efficient proton transport and minimal degradation.

Many of the techniques for fabrication are energy intensive and do not result in desired properties. Thus, what the industry needs are improved sintered solid state electrolytes and electrolyte precursors having uniform elemental distribution and being of a small, uniform diameter as well as other characteristics to provide densely packed electrolytes, preferably of a pure phase material.

### SUMMARY

The field of proton-conducting ceramic electrolytes has faced longstanding challenges related to achieving high ionic conductivity, phase purity, and uniform elemental distribution, particularly when using conventional solid-state reaction methods. Traditional approaches often require high calcination and sintering temperatures, which can result in elemental segregation, grain coarsening, and the formation of undesirable secondary phases, degrading the performance and reliability of solid oxide cells and related devices. The present teachings can address these problems by providing novel compositions and structures that enable lower processing temperatures, improved microstructural control, and enhanced electrochemical performance, thereby overcoming the limitations of existing methodologies and advancing the field of energy conversion and storage materials.

In one aspect, a proton-conducting ceramic electrolyte is provided, including a sintered multi-metal oxide solid solution defined by grains that derive from pre-sintered precursor particulates having an average particle diameter from 1 nanometer to 20 nanometers. The sintered multi-metal oxide solid solution can have a uniform elemental distribution across and within individual grains. The individual grains can exhibit a single crystalline phase with minimal secondary phases detectable by x-ray diffraction.

In another aspect, a solid oxide cell is provided including a proton-conducting ceramic electrolyte as described herein, disposed between an anode and a cathode.

In yet another aspect, an apparatus is provided including a plurality of solid oxide cells, each including a proton-conducting ceramic electrolyte as described above sandwiched between an anode and a cathode, where the plurality of solid oxide cells being are in electrical communication in series or in parallel.

These and other features will be more clearly understood from the following drawings, detailed description and examples as well as the appended claims.

### BRIEF DESCRIPTION OF THE DRAWINGS

The features and advantages of the present teachings are apparent from the following description taken in conjunction with the accompanying drawings.

FIGS. 1A-1E are X-ray diffraction (XRD) spectra or patterns of BCZYYb7111 (BaCe_{0.7}Zr_{0.1}Y_{0.1}Yb_{0.1}O₃) prepared with conventional solid state reaction methods, showing the progression of calcination over time and increased temperature, where FIG. 1A is after the first 8 hours (h) at 1100° C.; FIG. 1B is after the second 8 h at 1100° C.; FIG. 1C is after the third 8 h at 1200° C.; FIG. 1D is after the next 10 h at 1200° C.; and FIG. 1E is after the last 10 h at 1200° C.

FIGS. 2A-2F are X-ray diffraction (XRD) spectra or patterns of embodiments of fabricated BCZYYb7111 electrolyte prepared with a semi-batch method, followed by different calcination temperatures, where FIG. 2A is a commercial batch material from Korea; FIG. 2B is a semi-batch material calcinated at 1110° C.; FIG. 2C is a semi-batch material calcinated at 900° C.; FIG. 2D is a semi-batch material calcinated at 800° C.; FIG. 2E is a semi-batch material calcinated at 400° C.; and FIG. 2F is a semi-batch material before calcination.

FIG. 3 is a scanning electron microscope (“SEM”) image of BCZYYb powder from a solid-state reaction method.

FIG. 4 is a SEM image of BCZYYb powder from a semi-batch method.

FIG. 5 is a SEM image of protonic ceramic fuel cell (“PCFC”) cross-section with the electrolyte prepared from solid-state reaction method.

FIGS. 6A and 6B are SEM images of BCZYYb7111 electrolyte particles calcined at 900° C.

FIG. 7 is SEM and energy dispersive spectroscope (“EDS”) mapping of the metallic components of BCZYYb7111 calcined at 900° C.

FIG. 8 is a sinterability evaluation, showing the surface of a BCZYYb7111 pellet after sintered at 1500° C. for 2 h, 4 h, and 8 h.

FIG. 9 is a schematic diagram of a semi-batch reactor of the present teachings, used for making the electrolytes or proton-conducting materials of the present teachings.

FIG. 10 is a graph that depicts proton conductivity versus the reciprocal of temperature, where the protonic conductivity of a BCZYYb7111 pellet is measured after being sintered at 1450° C. under humidified nitrogen for 2 h, 4 h, and 8 h. The electrical conductivity evaluation was conducted at temperatures from about 350° C. to about 850° C.

FIG. 11 is a graph that depicts voltage or power density versus current density for a solid oxide fuel cell. The results of the solid oxide fuel cell performance evaluation is conducted over the temperature range from 500° C. to 700° C. The electrolyte was fabricated with the semi batch method of the present teachings.

### DETAILED DESCRIPTION OF THE INVENTION

Disclosed herein are methods and apparatus for fabricating electrolyte precursors, or proton conductor precursors or precursor particulates, which can have uniform elemental distribution and a small particle size (about 20 nm or less such as 10 nm or less, or 5 nm or less, but greater than 0.01 nm, or 0.1 nm). The small particle size is believed to allow the reduction of phase formation temperature and densification temperature of the electrolyte.

Currently researchers mainly use solid state reaction (“SSR”) methods to fabricate an solid state electrolyte material, for example, by mixing the metal oxides in stoichiometric ratios and calcining at elevated temperatures. SSR uses multiple grinding, mixing and calcination processes. The calcination is conducted at a high temperature over 1100° C.

In contrast, the products from a one-step semi-batch reaction or reactor can have a uniform elemental distribution and only use a low temperature treatment at 900° C. to form the pure perovskite phase.

The particle size that results from a semi-batch reactor method can be smaller than the particulates or powder produced by SSR. Small particle size facilitates the densification of ceramics and brings down the sintering temperature of a final product, such as a protonic ceramic fuel cell (“PCFC”). A high sintering temperature often causes elemental segregation, interaction with support component, and larger grain size, all of which can reduce the performance of the PCFC.

As used herein, “electrolyte” generally refers to a material including sintered electrolyte particulates that can form a dense electrolyte substrate such as a layer. An electrolyte can have a uniform elemental distribution. An electrolyte can be a pure phase material. An electrolyte can have its pre-sintered electrolyte particulates have an average diameter of less than or equal to 20 nm.

As used herein, “sintered electrolyte particulate” generally refers to a particle of electrolyte material that has undergone sintering, resulting in a dense, pure phase with uniform elemental distribution.

As used herein, “ceramic” generally refers to an inorganic, non-metallic solid formed from a composition that includes metal oxides, metal nitrides, metal carbides, or metal oxynitrides. A ceramic forms by heating the composition to a temperature sufficient to cause densification, grain growth, or solid-state bonding of particulate material. A ceramic exhibits ionic or electronic conductivity, thermal stability, and mechanical rigidity under elevated-temperature operating conditions associated with solid oxide cells. Generally, ceramics do not exhibit carbon-hydrogen bonds, do not exhibit free-electron conduction like metals, have high melting points, exhibit hardness and brittleness and are chemically stable at high temperatures. Some non-limiting examples include zirconia (ZrO₂), yttria-stabilized zirconia (YSZ), ceria (CeO₂), alumina (Al₂O₃) and perovskites (e.g., lanthanum strontium manganite (LSM), La₁₋ₓSrₓCo_{1-γ}Fe_{γ}O₃-δ (LSCF), and Ba_{0.5}Sr_{0.5}Co_{0.8}Fe_{0.2}O₃-δ (BSCF)).

As used herein, “sintered ceramic” or “sintered metal oxide” generally refers to a solid inorganic material formed by heating a particulate ceramic composition to a temperature below the melting point of the composition to cause bonding of adjacent particulates through solid-state diffusion. A sintered ceramic exhibits a continuous grain structure, mechanical rigidity, and thermal stability under the elevated-temperature conditions associated with solid oxide cell operation. A sintered ceramic can include residual porosity or can form as a dense structure depending on the processing temperature and the particulate composition.

As used herein, “dense ceramic electrolyte” generally refers to a ceramic layer that exhibits a continuous, non-porous structure that supports ionic transport at elevated temperature. A dense ceramic electrolyte includes a sintered ceramic material that defines substantially no interconnected porosity through the thickness of the layer. A dense ceramic electrolyte maintains gas separation between adjacent electrode layers in a solid oxide cell and provides a continuous path for oxygen-ion conduction or proton conduction depending on the ceramic composition.

As used herein, “solid solution” generally refers to a single-phase crystalline material in which two or more types of atoms, ions, or molecules are distributed within the crystal lattice, forming a homogeneous structure at the atomic level without the presence of separate phases or boundaries between the constituent components.

As used herein, “solid oxide cell” (“SOC”) generally refers to an electrochemical device that generates an electrical output or a chemical output through reactions that occur across a solid electrolyte. The device includes a solid electrolyte between an anode layer and a cathode layer. The electrolyte can be ceramic. The device operates at an elevated temperature such as between 450° C. and 100° C. The device enables ionic transport through the solid electrolyte without use of a liquid phase.

As an example, a solid oxide cell can include a zirconia-based ceramic electrolyte between a nickel-containing anode layer and a lanthanum-strontium-manganite cathode layer. The example generates an electrical current when a fuel stream contacts the anode layer and when an oxidizer stream contacts the cathode layer. Other examples include structures with a scandia-stabilized zirconia electrolyte, a ceria-based electrolyte, a cobaltite-based cathode, or a perovskite-based anode.

As used herein, “uniform elemental distribution” generally refers to a state where the elements within a material are substantially evenly distributed, which can contribute to improved material properties.

As used herein, “pure phase material” generally refers to a material consisting substantially of a single crystalline phase, without impurities or secondary phases. XRD can be used to identify the crystalline phases present in the material and to confirm the absence of secondary phases or impurities. Rietveld refinement of XRD data can be performed to quantify the phase composition and to verify that the material consists substantially of a single crystalline phase. Quantitative values for pure phase material can be defined by the presence of a single set of diffraction peaks corresponding to the target phase, with no detectable peaks attributable to secondary phases above the instrument detection limit. The detection limit can be less than 1% or 2% weight percent for most laboratory XRD instruments. The phase purity can be further supported by the absence of secondary phases in SEM imaging and by consistent elemental ratios confirmed by inductively coupled plasma optical emission spectroscopy (ICP-OES) or atomic absorption spectroscopy (AAS).

As used herein, “pre-sintered electrolyte particulate” generally refers to a particle that has not yet undergone sintering and has an average diameter of less than or equal to 20 nm, less than or equal to 10 nm, or less than or equal to 5 nm.

As used herein, “lanthanide oxide elements” generally refers to the group of oxides including praseodymium oxide (Pr₂O₃), neodymium oxide (Nd₂O₃), samarium oxide (Sm₂O₃), europium oxide (Eu₂O₃), gadolinium oxide (Gd₂O₃), terbium oxide (Tb₄O₇), dysprosium oxide (Dy₂O₃), holmium oxide (Ho₂O₃), erbium oxide (Er₂O₃), thulium oxide (Tm₂O₃), and ytterbium oxide (Yb₂O₃).

As used herein, “alkaline earth oxides” generally refer to beryllium oxide (BeO), magnesium oxide (MgO), calcium oxide (CaO), strontium oxide (SrO), and barium oxide (BaO).

As used herein, “stoichiometric ratio” generally refers to the precise ratio of reactants required for a chemical reaction to proceed without excess of any reactant.

As used herein, “calcination” generally refers to a thermal process used to convert precursor materials into a desired phase, typically involving heating at high temperatures, for example, from 1000° C. to 1500° C.

As used herein, “ammonium base” generally refers to a base such as ammonium hydroxide (NH₄OH), ammonium carbonate ((NH₄)₂CO₃), or ammonium bicarbonate (NH₄HCO₃), or a combination thereof, used to precipitate electrolyte precursor particles from solution.

As used herein, “metal nitrate” generally refers to a nitrate salt of a metal, including but not limited to barium nitrate (Ba(NO₃)₂), cerium nitrate (Ce(NO₃)₃), yttrium nitrate (Y(NO₃)₃), zirconium nitrate (Zr(NO₃)₄), zirconium oxygen nitrate (ZrO(NO₃)₂), ytterbium nitrate (Yb(NO₃)₃), lanthanum nitrate (La(NO₃)₃), strontium nitrate (Sr(NO₃)₂), scandium nitrate (Sc(NO₃)₃), praseodymium nitrate (Pr(NO₃)₃), and gadolinium nitrate (Gd(NO₃)₃).

As used herein, “niobium oxalate” (Nb(C₂O₄)₅) generally refers to a niobium-containing precursor used in the synthesis of certain electrolytes.

As used herein, “aging time” generally refers to the period during which a precipitate is allowed to remain in solution to complete the formation process before collection.

As used herein, “washing” generally refers to the process of removing impurities from precipitated particles, typically using deionized water (DI water).

As used herein, “drying” generally refers to the process of removing moisture from washed particles, which can be performed at elevated temperature or under vacuum.

As used herein, “pellet” generally refers to a small, compacted mass of powder, often used in material testing and device fabrication.

As used herein, “theoretical density” generally refers to the maximum possible density of a material, assuming no porosity.

As used herein, “electrical conductivity” generally refers to the ability of a material to conduct an electric current, typically measured in Siemens per centimeter (S/cm).

As used herein, “proton conduction” generally refers to the movement of protons (H⁺ ions) through the electrolyte material.

As used herein, “elemental segregation” generally refers to the separation of various components within a material, often undesirable as this phenomenon can diminish performance.

As used herein, “sintering” generally refers to a process of compacting and heating powders to create dense ceramic components.

As used herein, “phase formation temperature” generally refers to the temperature at which a precursor material transforms into the desired crystalline phase.

As used herein, “densification temperature” generally refers to the temperature required to achieve a dense, compact structure in a ceramic or electrolyte material.

As used herein, “scanning electron microscope” (SEM) generally refers to an instrument used to image the surface morphology and particle size of materials.

As used herein, “energy-dispersive spectroscopy” (EDS) generally refers to a technique used in conjunction with SEM to analyze the elemental composition and distribution within a sample.

As used herein, “x-ray diffraction” (XRD) generally refers to an analytical technique used to determine the phase purity and crystal structure of materials.

As used herein, “bio-logic potentiostat” generally refers to an instrument used to control and measure electrical potentials and currents in electrochemical experiments.

As used herein, “electrochemical impedance spectroscopy” (EIS) generally refers to a technique for measuring the resistivity and conductivity of materials by applying an alternating current and analyzing the response.

As used herein, “nanoscale size” generally refers to a particle size in the nanometer range (typically less than 100 nm), often associated with improved material properties.

As used herein, “solution casting” generally refers to a fabrication technique where polymer precursors are dissolved in solvents, cast, and evaporated to form membranes.

As used herein, “mechanical stirring” generally refers to a method of mixing solutions using a mechanical device to agitate the mixture.

As used herein, “peristaltic pump” generally refers to a device used to control the flow rate of liquids during the addition of solutions in chemical processes.

As used herein, “syringe pump” generally refers to a device for precise, low flow rate addition of liquids, often used in laboratory-scale chemical processes.

As used herein, “vacuum filtration” generally refers to a technique for separating solids from liquids using a vacuum to draw the liquid through a filter.

As used herein, “vacuum drying” generally refers to a process of removing moisture from materials under reduced pressure to prevent oxidation or contamination.

As used herein, “room temperature” generally refers to a temperature range typically between 20° C. and 30° C., used as a standard condition for chemical reactions.

As used herein, “di water” generally refers to deionized water, used for washing and rinsing materials to remove impurities.

### Electrolytes

In one aspect, the present teachings provide electrolytes that include sintered electrolyte particulates that can exhibit a uniform elemental distribution. The electrolytes can be characterized as pure phase materials. The electrolyte particulates are produced from pre-sintered electrolyte particulates having an average diameter of less than or equal to 20 nm, which can enable enhanced control over the microstructure and properties of the resulting electrolyte. The uniform elemental distribution within the sintered particulates can contribute to improved ionic conductivity and stability, while the pure phase nature can ensure minimal presence of impurities or secondary phases that could otherwise degrade performance.

The sintered electrolyte particulates of the present teachings can include one or more metal oxides selected from the group consisting of yttrium oxide, scandium oxide, zirconium oxide, hafnium oxide, niobium oxide, tantalum oxide, calcium oxide, strontium oxide, barium oxide, praseodymium oxide, neodymium oxide, samarium oxide, europium oxide, gadolinium oxide, terbium oxide, dysprosium oxide, holmium oxide, erbium oxide, thulium oxide, and ytterbium oxide. The inclusion of these metal oxides allows for the tailoring of the electrolyte's chemical composition and functional properties to suit specific applications, such as fuel cells, sensors, or other electrochemical devices. In some embodiments, the sintered electrolyte particulates can include two or more, three or more, four or more, or five or more metal oxides selected from the group, providing further flexibility in designing multi-component systems with synergistic effects on conductivity, mechanical strength, and chemical stability.

Furthermore, the pre-sintered electrolyte particulates can be engineered to have an average diameter of less than or equal to 10 nm, or even less than or equal to 5 nm. For example, the average diameter can be less than or equal to about 9 μm, less than or equal to about 8 μm, less than or equal to about 7 μm, or less than or equal to about 6 μm. In some embodiments, the average diameter can be less than or equal to about 4 μm, less than or equal to about 3 μm, less than or equal to about 2 μm, or less than or equal to about 1 μm, with the lower bound of these diameters being 0.01 nm, or 0.1 nm. The small-diameter pre-sintered electrolyte particulates can result in a higher surface area, improved sintering behavior, and enhanced performance characteristics in the final electrolyte material. The ability to control particle size at the nanoscale is particularly advantageous for achieving dense, uniform microstructures and optimizing the functional properties of the electrolyte for advanced energy conversion and storage technologies.

In some embodiments, the sintered multi-metal oxide solid solution has a perovskite structure of nominal formula ABO₃-δ, in which A (or the “A-site”) includes at least one alkaline earth metal oxide and B (or the “B-site”) includes at least one of cerium oxide, zirconium oxide, and a lanthanide metal oxide, and 0<δ≤0.2. The A-site can include barium oxide alone or in combination with strontium oxide or calcium oxide such that the A-site occupancy is represented by Ba₁₋ₓA, with A selected from CaO and SrO and 0<x≤0.5. The B-site can include a cerium oxide-zirconium oxide solid solution acceptor-doped with at least one lanthanide metal oxide selected from yttrium oxide, ytterbium oxide, scandium oxide, gadolinium oxide, and neodymium oxide in a total dopant fraction between 0.05 and 0.30 relative to the B-site. The composition can be represented by BaCe_{1-γ-}zZr_{γ}M_{γ}M′zO₃-δ, where M and M′ are independently selected from Y₂O₃, Yb₂O₃, Sc₂O₃, Gd₂O₃, and Nd₂O₃, 0.05≤(y+z)≤0.30, 0≤y≤0.30, 0≤z≤0.30, and 0<δ≤0.2. The A-site to B-site cation ratio can be between 0.95 and 1.05 on a molar basis. The zirconium oxide content on the B-site can be between 0.05 and 0.40 on a molar basis, and the lanthanide metal oxide dopant content on the B-site can be between 0.08 and 0.20 on a molar basis. The molar ratio of cerium oxide to zirconium oxide can be between 3:1 and 9:1.

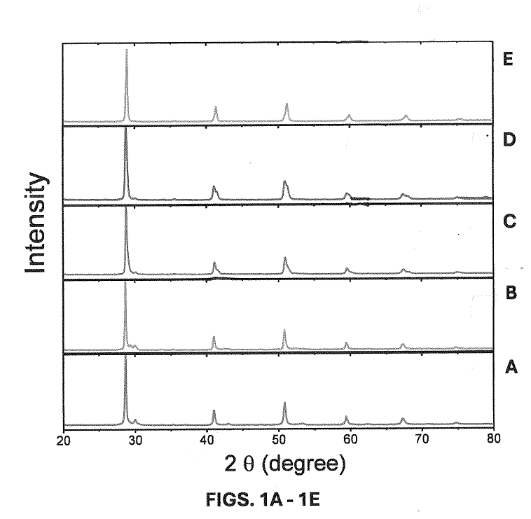

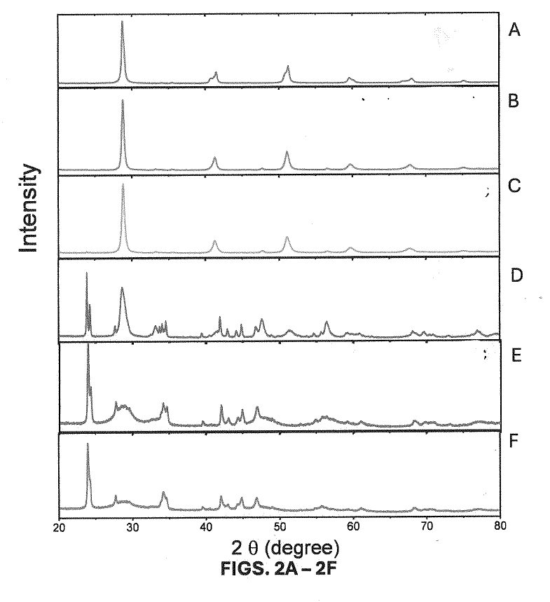

FIGS. 1A-1E are XRD patterns of solid-state reaction processed electrolytes calcinated at varying temperatures and durations, illustrating the higher temperature that is desirable to form the product. FIG. 2 is a graph illustrating XRD patterns of various electrolytes of the present teachings, showcasing phase evolution and crystallinity under different processing temperature conditions.

More specifically, FIG. 2 shows the x-ray diffraction (XRD) pattern of the fabricated Ba, Ce, Zr, Y, and Yb (“BCZYYb”) precursor subjected to calcination at various temperatures. The XRD analysis is employed to evaluate the phase purity and crystalline structure of the material made under different thermal conditions, providing insights into the phase formation and stability of the BCZYYb electrolyte.

The XRD pattern includes data for the precursor before calcination, as well as after calcination at 400° C., 800° C., 900° C., and 1100° C. Additionally, the pattern of a commercial BCZYYb sample is provided for comparison. The precursor before calcination exhibits broad peaks, indicative of an amorphous or poor crystalline structure. This is consistent with the initial state of the material prior to thermal treatment.

At 400° C., the XRD pattern shows the emergence of sharper peaks, suggesting the onset of crystallization. However, the pattern indicates the presence of multiple phases, implying incomplete phase formation at this temperature. As the calcination temperature increases to 800° C., the peaks become more defined, and the pattern begins to resemble the characteristic diffraction profile of a BCZYYb electrolyte. This indicates significant progress in the formation of the desired crystalline phase.

At 900° C., the XRD pattern demonstrates further refinement of the peaks, with reduced noise and improved intensity. This suggests enhanced crystallinity and phase purity, as the material approaches the temperature conducive to phase formation. The pattern at 1100° C. exhibits sharp, well-defined peaks that closely match the commercial BCZYYb sample, confirming the successful formation of a material with a pure phase. The comparison with the commercial sample validates the effectiveness of the calcination process in achieving the desired crystalline structure.

The progression of the XRD patterns highlights the significant influence of calcination temperature in achieving phase formation and purity. The data underscores the importance of optimizing thermal treatment conditions to produce high-quality BCZYYb electrolytes suitable for applications in solid oxide cells and other electrochemical devices. The calcination temperature or sintering temperature can be adapted accordingly based on the intrinsic material properties.

It was unexpectedly found that the calcination temperature can be varied for different materials based on the characteristics of the electrolyte precursor compounds, and in particular, can be lowered by about 100° C. to about 200° C. from the calcinating or sintering temperature for a precursor from an SSR process. It is desirable for the electrolyte to have a crystallinity of greater than 90 wt %, preferably greater than 95 wt %, more preferably greater than 99 wt % and preferably 100 wt %.

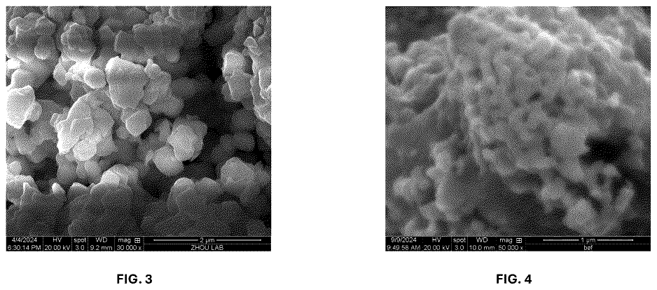

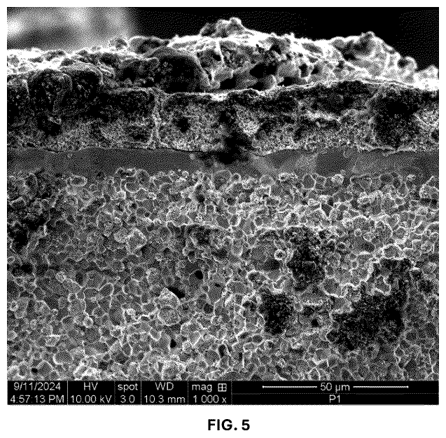

FIGS. 3 and 4 are scanning electron microscope (SEM) images of the surface morphology of BCZYYb electrolyte materials, prepared using SSR (FIG. 3) or using semi-batch method (FIG. 4). These figures can provide detailed insight into the microstructural features of the proton-conducting material. The image highlights the nanoscale characteristics of the material, which play a significant role in enabling functionality in applications such as fuel cells, sensors, and electrochemical devices.

The material surface depicted in FIGS. 3 and 4 demonstrate a porous structure with interconnected particles, which is indicative of a higher surface area. Such a morphology is advantageous for proton conductors as the design facilitates efficient proton transport by providing multiple pathways for proton migration. The nanoscale size of the particles further enhances the proton conductivity of the material due to the increased interface area, which promotes the vehicle mechanism and Grotthuss mechanism of proton transport.

With reference to FIGS. 3 and 4, the porous network of the material can be further characterized by quantitative measurements of porosity and surface area. In typical solid oxide cells (SOCs), the porosity of the electrolyte or electrode layer can range from 5% to 30%, specifically including 5%, 10%, 15%, 20%, 25%, and 30%. The porosity also includes ranges such as 5% to 25%, 5% to 20%, 5% to 15%, and 5% to 10% as well as 10% to 30%, 10% to 25%, 10% to 20%, and 10% to 15%. The specific surface area, for example, as determined by Brunauer-Emmett-Teller (BET) analysis, can range from 1 m²/g to 20 m²/g. The specific surface area can include 1 m²/g, 5 m²/g, 10 m²/g, 15 m²/g, and 20 m²/g. The specific surface area also includes 1 m²/g to 19 m²/g, 1 m²/g to 15 m²/g, 1 m²/g to 10 m²/g, as well as 5 m²/g to 20 m²/g, 5 m²/g to 15 m²/g, 5 m²/g to 15 m²/g, 5 m²/g to 10 m²/g, 10 m²/g to 20 m²/g. These quantitative characteristics are important for optimizing the interaction between the electrolyte and other cell components, and for supporting the high ionic conductivity required in advanced SOC applications.

As can be seen, FIG. 4 is almost double the magnification of FIG. 3, yet the particulates that make up the structure in FIG. 4 appear much smaller than those in FIG. 3, providing insight into the morphological differences between the electrolytes. The dense arrangement of particles observed in FIG. 4 can also be attributed to the sintering process, which can be correlated with the electrochemical performance of the material. For example, the nanoscale features and uniform distribution of particles, including Ba, Ce, Zr, Y, and Yb, are anticipated to contribute to reduced resistivity and enhanced proton conductivity, as confirmed by techniques such as electrochemical impedance spectroscopy (“EIS”).

FIG. 5 shows a microscopy image of a layered SOC related material structure, providing a detailed visualization of the microstructural features of the proton-conducting electrolyte material. The image highlights the morphology, porosity, and distribution of phases within the SOC, which can play a significant role in understanding the proton conductivity and mechanical stability of the electrolyte material.

The microstructure depicted in FIG. 5 reveals a nanoscale porous network, enhancing proton transport by increasing the surface area and facilitating the movement of protons through interconnected pathways. The image demonstrates the presence of distinct regions within the material, which correspond to different phases or layers. The porous structure also suggests the potential for infiltration with proton-conductive polymers or electrolytes, which can further improve the material's performance.

The porous network of the microstructure can be quantitatively characterized by the porosity of the material, which can be measured as the percentage of the total volume of the material that is occupied by pores. The porosity of the microstructure can range from 5% to 30%, specifically including 5%, 10%, 15%, 20%, 25%, and 30%. The porosity also includes ranges such as 5% to 25%, 5% to 20%, and 5% to 15% as well as 10% to 30%, 10% to 25%, 10% to 20%, and 10% to 15%. The level of porosity can be determined by image analysis of SEM micrographs or by mercury intrusion porosimetry.

The granular features observed in FIG. 5 suggest the material underwent processing such as sintering. These processes play a significant role in achieving a dense, pure phase material with uniform elemental distribution. The presence of well-defined grains and boundaries indicates successful densification, which contributes to the mechanical stability and durability of the material.

Overall, FIG. 5 provides a detailed view of the material's microstructure, highlighting significant features that contribute to the functionality of the material as a proton conductor. The image serves as an important resource for assessing the material's properties and enhancing performance for applications in fuel cells, sensors, and electrochemical devices.

To that end, in another aspect, a solid oxide cell is provided including a proton-conducting ceramic electrolyte as described herein, disposed between an anode and a cathode. The electrolyte can be a dense film having a thickness of 5 to 50 micrometers. The electrolyte can have a bulk density of at least 95 percent of theoretical. The solid oxide cell can be configured to operate in a temperature range of 400° C. to 800° C. The anode and cathode can be co-fired or co-sintered with the electrolyte to form an integrated cell structure, or can be tape-cast or screen-printed onto a porous support to produce a dense electrolyte layer on a mechanically robust substrate.

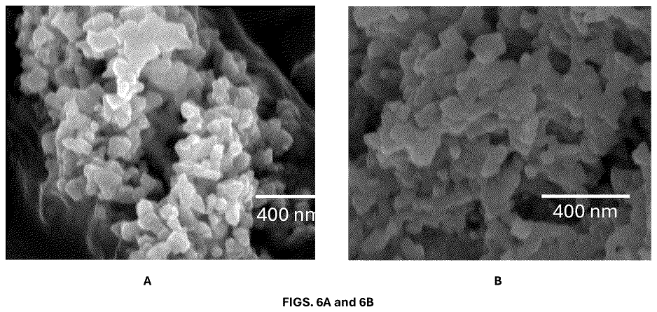

FIG. 6 shows a SEM image of a BCZYYb7111 electrolyte that has undergone calcination at 900° C. The image provides a detailed visualization of the surface morphology and microstructure of the synthesized particles, which are significant for analyzing their role as proton conductors.

The SEM image reveals the formation of dense, well-defined particles with a nanoscale size, which is desirable for achieving high proton conductivity. The calcination process at 900° C. has facilitated the development of a pure phase material, as evidenced by the uniform and consistent particle morphology. The high-temperature treatment ensures the removal of residual precursor materials and promotes the formation of the desired crystalline phase, which significantly contributes to optimizing the proton transport properties of the BCZYYb7111 electrolyte.

The particles demonstrate a compact and interconnected structure, which reflects effective sintering during the calcination process. This interconnected morphology supports proton conduction by reducing resistance to proton migration and promoting the overall ionic conductivity of the material. Additionally, the nanoscale size of the particles increases the surface area, facilitating improved interaction between the electrolyte and other components in solid oxide cells (SOC).

The uniform elemental distribution within the BCZYYb7111 particles, achieved through stoichiometric control during synthesis and subsequent processing including calcination, helps to maintain consistent material properties. The absence of elemental segregation, which can negatively impact performance, can be an important characteristic of the calcined particulates. This uniformity can ensure that the proton-conducting pathways are evenly distributed throughout the material, which can lead to enhanced efficiency in electrochemical applications.

Based on the analysis and results, a calcination temperature of about 900° C. is favored to balance phase formation and densification, ensuring the production of high-quality electrolyte particles.

In sum, FIG. 6 demonstrates the successful synthesis and calcination of BCZYYb7111 electrolyte particles, showcasing their nanoscale size, dense microstructure, and uniform elemental distribution. These characteristics can play a significant role in enhancing proton conductivity and ensuring the material's suitability for advanced electrochemical applications.

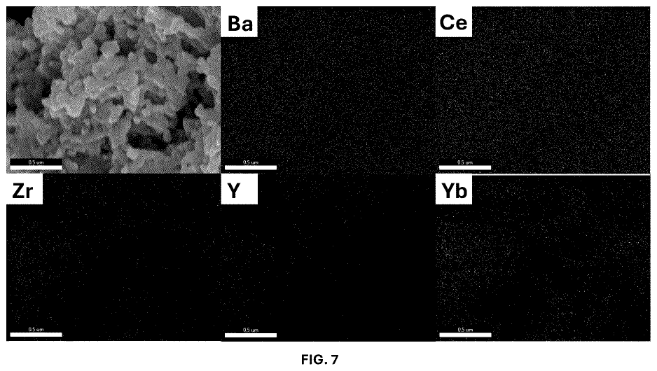

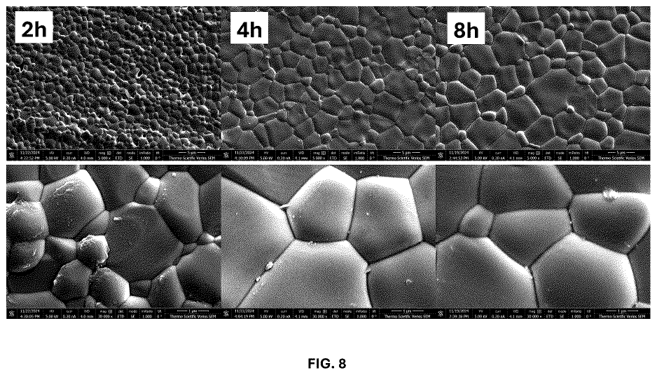

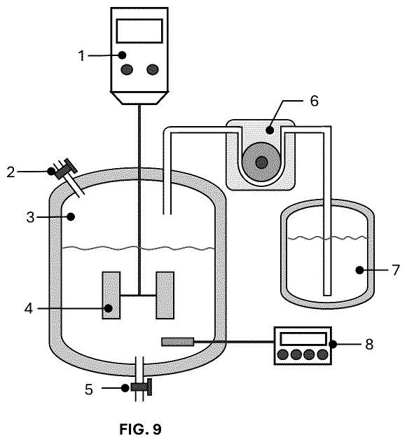

FIG. 7 illustrates a scanning electron microscope (SEM) image and energy-dispersive spectroscopy (EDS) mapping of the proton-conducting electrolyte BCZYYb7111 (including barium (Ba), cerium (Ce), zirconium (Zr), yttrium (Y), and ytterbium (Yb) following calcination at 900° C. The figure can offer material observations regarding the material's microstructure and elemental distribution, which contribute to assessing its effectiveness as a proton conductor.

The SEM image illustrates the surface morphology of the calcined BCZYYb7111 material, revealing a dense and uniform microstructure. This dense structure reflects the effectiveness of the sintering and calcination processes in promoting high proton conductivity and mechanical stability. The absence of visible porosity in the SEM image indicates that the material has undergone successful densification, which contributes to reducing resistance and improving ionic transport.

The EDS mapping provides a spatial distribution of the primary elements present in the BCZYYb7111 composition, including Ba, Ce, Zr, Y, and Yb. The individual elemental maps demonstrate a uniform distribution of these elements across the material, which is important for ensuring consistent proton conductivity and preventing performance degradation due to elemental segregation. Uniform elemental distribution also contributes to the formation of a single-phase material, which is desirable for maintaining the theoretical density and enhancing the electrochemical properties of the electrolyte. The uniform elemental distribution results in a homogenous structure with isotropic properties.

The presence of Ba, Ce, Zr, Y, and Yb in the mapped regions confirms the successful incorporation of these elements into the BCZYYb7111 structure during the synthesis and calcination processes. The uniformity of the elemental mapping further indicates that the stoichiometric ratios of the precursors were accurately maintained during the synthesis, ensuring the formation of the desired crystalline phase.

The calcination temperature of 900° C., as indicated in FIG. 4, is an important parameter for achieving the phase formation temperature required for the BCZYYb7111 material. This thermal treatment facilitates the development of the desired crystal structure, enhancing proton migration through the material. Additionally, the calcination temperature contributes to the elimination of residual precursor materials, resulting in a pure phase material with improved conductivity and stability.

The combination of SEM imaging and EDS mapping (not shown in color) provides a detailed analysis of the BCZYYb7111 material, highlighting the material's suitability as a proton-conducting electrolyte for applications in solid oxide cells (SOC) and other electrochemical devices. The dense microstructure and uniform elemental distribution that can be observed are indicative of the strong performance and reliability of the material in facilitating proton transport.

FIG. 7 shows microscopic images of a sintered pellet composed of BCZYYb7111. The figures illustrate a sinterability evaluation of the material after thermal treatment at 1500° C. for various times. The images provide a comparative analysis of the microstructural evolution of the pellet surface over sintering times of 2 hours, 4 hours, and 8 hours, demonstrating the increase in grain size and reduction of porosity at higher temperatures and longer times.

The image corresponding to the 2-hour sintering duration reveals a microstructure characterized by smaller grains and a higher degree of porosity. This observation suggests that the densification process is still progressing, with restricted grain growth and partial removal of voids.

The image corresponding to the 4-hour sintering duration demonstrates significant grain growth and a reduction in porosity compared to the 2-hour sintering. The grains appear more uniform, and the boundaries between grains are more defined, suggesting improved densification.

The image corresponding to the 8-hour sintering duration shows a fully densified microstructure with large, well-defined grains and minimal porosity. The grain boundaries are smooth and continuous, indicating the completion of the densification process.

The progression of microstructural changes observed in FIG. 7 highlights the significance of sintering temperature and duration in achieving the desired phase purity and densification. The thermal treatment at 1500° C. facilitates the transformation of the precursor material into a dense, large grain material with reduced porosity.

### Methods of Making Electrolytes

In another aspect, the methods of the present teachings include the ability to produce electrolyte precursor particles with nanoscale size and uniform elemental distribution, which can enable lower processing temperatures, improved microstructural control, and enhanced electrochemical performance. In certain embodiments, the small particle size allows for reduction of phase formation temperature and densification temperature, resulting in reduced grain size, improved proton conduction, and reduced elemental segregation during calcination. For example, each of the phase formation temperature and the densification temperature can be lowered 50° C., 100° C., 150° C., 200° C. or 250° C. The lower temperatures can result in a reduced grain size and reduced elemental segregation. Such characteristics can provide a electrolyte with improved proton conduction. In some embodiments, the methods provide adaptability with respect to choice of metal precursors, acid inclusion, ammonium base composition, addition rate, washing and drying protocols, calcination temperature, reactor size, stirring method and rate, flowrate control, aging time, and precipitation conditions, while consistently producing high-quality electrolyte materials suitable for advanced energy conversion and storage applications.

In various embodiments, methods of making the electrolytes of the present teachings include preparing standardized aqueous solutions of metal nitrates, optionally including an acid, and mixing the metal nitrates at desired stoichiometric amounts to form a mixed nitrate solution. In some embodiments, the mixed nitrate solution is contacted with an ammonium base to drop out or precipitate particles of an electrolyte precursor having an average particle diameter of less than or equal to 20 nanometers, specifically including less than or equal to 1 nanometer, 2 nanometers, 3 nanometers, 4 nanometers, 5 nanometers, 6 nanometers, 7 nanometers, 8 nanometers, 9 nanometers, 10 nanometers, 11 nanometers, 12 nanometers, 13 nanometers, 14 nanometers, 15 nanometers, 16 nanometers, 17 nanometers, 18 nanometers, 19 nanometers, and 20 nanometers, where the lower limit of these average diameters is 0.01 nanometers or 0.1 nanometers. The average particle diameter also includes 1 nanometer to 19 nanometers, 1 nanometer to 18 nanometers, 1 nanometer to 17 nanometers, 1 nanometer to 16 nanometers, 1 nanometer to 15 nanometers, 1 nanometer to 14 nanometers, 1 nanometer to 13 nanometers, 1 nanometer to 12 nanometers, 1 nanometer to 11 nanometers, 1 nanometer to 10 nanometers, 1 nanometer to 9 nanometers, 1 nanometer to 8 nanometers, 1 nanometer to 7 nanometers, 1 nanometer to 6 nanometers, 1 nanometer to 5 nanometers, 1 nanometer to 4 nanometers, 1 nanometer to 3 nanometers, and 1 nanometer to 2 nanometers.

In certain embodiments, the method further includes collecting and washing the precursor particles, drying the washed particles, and calcinating the electrolyte precursor at a temperature less than or equal to 900° C. to form the sintered multi-metal oxide solid solution. The calcination temperature also includes 800° C. to 900° C., 700° C. to 900° C., 600° C. to 900° C., 550° C. to 900° C., 800° C. to 850° C., 700° C. to 850° C., 600° C. to 850° C., 550° C. to 850° C., 700° C. to 800° C., 600° C. to 800° C., 550° C. to 800° C., 700° C. to 750° C., 600° C. to 750° C., and 550° C. to 750° C.

In some embodiments, the method includes using metal nitrates selected from barium nitrate, cerium nitrate, yttrium nitrate, zirconium nitrate, and ytterbium nitrate, and acids such as nitric acid. In certain embodiments, the ammonium base includes ammonium hydroxide, ammonium carbonate, ammonium bicarbonate, or combinations thereof. In some embodiments, the mixed nitrate solution is added to an aqueous ammonium solution at a rate of about 1 mL/min to about 10 mL/min, specifically including 1 mL/min, 2 mL/min, 3 mL/min, 4 mL/min, 5 mL/min, 6 mL/min, 7 mL/min, 8 mL/min, 9 mL/min, and 10 mL/min. The addition rate also includes 1 to 9 mL/min, 1 to 8 mL/min, 1 to 7 mL/min, 1 to 6 mL/min, 1 to 5 mL/min, 1 to 4 mL/min, 1 to 3 mL/min, and 1 to 2 mL/min. In certain embodiments, treating and collecting includes washing the particles of electrolyte precursor and drying the washed particles at an elevated temperature, for example, at 80° C. for 24 hours, or under vacuum at room temperature.

In various embodiments, the method includes aging the mixture with continued stirring for a period that can range from 30 minutes to 2 hours, or more. In certain embodiments, the method includes using a semi-batch reactor, as depicted in FIG. 9, with components such as a mixing speed controller, reaction vessel, mixing impeller, product discharge outlet, liquid transfer pump, metal precursor reservoir, and temperature sensor and thermostat control.

In some embodiments, the method includes confirming uniform elemental distribution by X-ray diffraction (XRD) and scanning electron microscope with energy-dispersive spectroscopy (SEM/EDS) analysis, performed in accordance with ASTM E1508 and ISO microanalysis guidelines. In certain embodiments, chemical composition and metal ratios can be confirmed by inductively coupled plasma optical emission spectroscopy (ICP-OES) or atomic absorption spectroscopy (AAS), performed in accordance with ASTM E1479.

XRD can be used to confirm the absence of secondary phases and the presence of a single crystalline phase, indicating homogeneous mixing of constituent elements at the atomic scale. SEM/EDS mapping can provide spatially resolved elemental analysis across and within individual grains of the sintered electrolyte. Quantitative values for substantially uniform elemental distribution can be defined by elemental concentration variations of less than ±5% relative to the average concentration for each constituent element, measured across multiple grains and regions of the sample. Elemental mapping by EDS can show that the standard deviation of elemental concentration for each metal cation is less than 5% of the mean value, and no regions of elemental segregation or clustering can be observed at the resolution of the SEM/EDS instrument. Uniformity can be further supported by the absence of detectable secondary phases in XRD patterns and by consistent elemental ratios confirmed by ICP-OES or AAS.

In various embodiments, the electrolyte precursor has uniform elemental distribution. In some embodiments, uniform elemental distribution is determined by X-ray diffraction (XRD) and scanning electron microscope with energy-dispersive spectroscopy (SEM/EDS) analysis. In some embodiments, the metal nitrates are selected from the group consisting of barium nitrate, cerium nitrate, yttrium nitrate, zirconium nitrate, zirconium oxygen nitrate, and ytterbium nitrate. In some embodiments, the acid includes nitric acid. In some embodiments, the ammonium base includes ammonium hydroxide, ammonium carbonate, and combinations thereof. In some embodiments, contacting the mixed nitrate solution with an ammonium base includes adding the mixed nitrate solution to an aqueous ammonium solution. In some embodiments, adding the mixed nitrate solution to an aqueous ammonium solution is at a rate of about 1 mL/min to about 10 mL/min. In certain embodiments, treating and collecting includes washing the particles of electrolyte precursor and drying the washed particles.

Advantageously, this disclosure provides a novel method to fabricate the proton conductor precursors, which exhibit uniform elemental distribution and small particle size (about 10 nm, or less, for example, between 0.1 nm and 5 nm, 6 nm, 7 nm, 8 nm, and 9 nm). The small particle size allows the reduction of phase formation temperature and densification temperature of the electrolyte. The resulting materials are suited for reducing the sintering temperature of proton ceramic electrolyte. This provides for reduced the sintering temperature, reduced grain size and improved proton conduction in the electrolyte, and also reduced elemental segregation during calcination.

In various embodiments, the method involves preparing standardized aqueous solutions of barium nitrate, cerium nitrate, and yttrium nitrate, optionally including nitric acid to enhance solubility, followed by mixing these solutions in stoichiometric ratios to form a mixed nitrate solution. The metal precursor can also be a soluble oxalate or soluble acetate, in addition to nitrate. The concentration of the metal precursor solution can vary from 0.1 to 1 mmol/g (metal ion based), and the concentration of ammonium hydroxide and ammonium carbonate aqueous solution can vary from 0.2 to 1.5 mmol/g (ammonium ion based). The mixed solution is then added at a controlled rate, which can range from 0.2 mL/min to 10 mL/min, to an aqueous ammonium hydroxide or ammonium carbonate solution, with the precipitate reagent being in excess by more than 20% of the stoichiometric ratio. Ammonium carbonate can be replaced by ammonium bicarbonate, in which case 1 mol additional ammonium hydroxide is required for each mole of ammonium bicarbonate. The precipitation reaction is performed at room temperature (20° C. to 30° C.), and the reactor size can vary from 250 mL to 2 L. Mixing can be achieved with either magnetic or mechanical stirring, with the stirring rate varying from 100 rpm to 600 rpm. When the flowrate of the metal precursor is low (0.2-1 mL/min) and the reactor volume is low (250-500 mL), a syringe pump can be used to replace a peristaltic pump.

After all metal precursors are added, the mixture is aged with continued stirring for a period that can range from 30 minutes to 2 hours to ensure complete precipitation of barium, strontium, or calcium as carbonate. The resulting electrolyte precursor particles, having an average diameter of less than or equal to 10 nm, are collected, washed with deionized water, and dried at 120° C. or under vacuum at room temperature. The precursor is then calcinated at a temperature less than or equal to 900° C., with the method capable of achieving at least a 100° C. reduction in calcination temperature to obtain uniform elemental distribution and pure phase material in a single step. Uniform elemental distribution can be confirmed by X-ray diffraction (XRD) and scanning electron microscope with energy-dispersive spectroscopy (SEM/EDS) analysis.

In some embodiments, the method utilizes a combination of zirconyl nitrate, scandium nitrate, and calcium nitrate as the metal sources, with ammonium carbonate or ammonium bicarbonate as the base, and the mixed nitrate solution is added at a slower rate of 2 mL/min to the ammonium solution. The resulting precursor particles are washed, dried, and calcinated at 900° C. In certain embodiments, the acid is omitted from the initial solutions, and the metal nitrates include praseodymium nitrate and gadolinium nitrate. The mixed nitrate solution can be introduced to a combination of ammonium hydroxide and ammonium carbonate, and the precursor particles can be collected, washed, and dried under vacuum at room temperature before calcination. Each embodiment demonstrates the adaptability of the method with respect to the choice of metal precursors, acid inclusion, ammonium base composition, addition rate, washing and drying protocols, calcination temperature, reactor size, stirring method and rate, flowrate control, aging time, and precipitation conditions, while consistently producing electrolyte precursor particles with the desired nanoscale size and uniform elemental distribution.

An example of a method for manufacturing of proton conducting electrolyte, BCZYYb7111 (BaCe_{0.7}Zr_{0.1}Y_{0.1}Yb_{0.1}O₃) is now introduced. The process begins with standardization of nitrate solutions. Barium nitrate, cerium nitrate and yttrium nitrate are mixed with water to obtain clear solutions. Zirconium oxygen nitrate and ytterbium nitrate are mixed with diluted nitric acid to prepare a clear solution. Thermogravimetric analysis is used to measure the concentration of metal ions in the nitrate solution.

Different metal nitrate solutions are mixed at the desired stoichiometric ratios, with the total concentration of 0.6˜0.8 mol/L. The mixed nitrate solution is pumped into the 1M ammonium hydroxide and ammonium carbonate solution, with a rate of 5 mL/min and stirring. After finishing dropping the solution, the particles are aged for 1 hour. The particles are separated and washed by centrifuging, followed by drying in the oven at 80° C. for 24 hours.

In perovskite phase formation, the dried particle then transferred into a crucible and calcined at 900° C. for 5 hours to form the desired BCZYYb7111 phase.

In some embodiments, an apparatus is provided for implementing the methods disclosed herein. A control system can be included. The control system can include machine readable instructions stored on non-transitory machine readable media, and configured for implementation by a processor and other electro-mechanical devices suited for controlling the apparatus.

The methods of the present teachings can be practiced with a semi-batch reactor, an exemplary embodiment of which is depicted in FIG. 9. More specifically, FIG. 9 shows a schematic diagram of a semi-batch reactor designed for the synthesis of proton-conducting materials. The reactor system integrates multiple components to facilitate controlled chemical reactions and ensure the production of high-purity materials.

The mixing speed controller 1 is configured to regulate the rotational speed of the mixing impeller 4 within the reaction vessel 3. This control ensures uniform mixing of reactants, which is desirable for achieving consistent reaction conditions and preventing localized concentration gradients that could lead to non-uniform product formation.

The ammonium hydroxide and ammonium carbonate solution feed 2 introduces the base solutions into the reaction vessel 3. These solutions act as precipitation reagents, facilitating the formation of solid precursor particles from dissolved metal ions. The flow rate of the feed can be precisely controlled to maintain optimal precipitation conditions.

The reaction vessel 3 serves as the primary container where the chemical reactions occur. The mixing impeller 4, integrated within the vessel, facilitates thorough agitation of the reactants, promoting homogeneity and effective interaction between the metal precursor and the precipitation reagents. The design of the impeller 4 is tailored to prevent sedimentation and maintain uniform particle size distribution.

The product discharge outlet 5 allows for the removal of the synthesized precursor particles from the reaction vessel 3. This outlet is strategically positioned to facilitate the collection of the precipitated product while minimizing contamination or loss of material.

The liquid transfer pump 6 is responsible for transferring the metal precursor solution from the metal precursor reservoir 7 to the reaction vessel 3. This pump enables precise control over the addition rate of the precursor solution.

The metal precursor reservoir 7 stores the solution containing metal salts, such as barium nitrate, cerium nitrate, or other relevant precursors. This reservoir is designed to maintain the stability of the precursor solution and facilitate the controlled delivery of the solution to the reaction vessel 3.

The temperature sensor and thermostat control 8 monitors and regulates the temperature within the reaction vessel 3. Maintaining the appropriate temperature is desirable for achieving the desired phase formation and improving the reaction kinetics. The thermostat control ensures that the temperature remains within the specified range, preventing overheating or underheating that could compromise the quality of the resulting material.

The semi-batch reactor depicted in FIG. 9 is particularly suited for the synthesis of proton-conducting materials, such as barium zirconate or metal-organic frameworks, which require precise control over reaction conditions, including temperature, mixing speed, and reagent addition rates. The integration of these components enables the production of high-quality materials with uniform elemental distribution and tailored properties for applications in fuel cells, sensors, and other electrochemical devices.

### Methods of Using Electrolytes

In another aspect, the present teachings provide methods of using the electrolytes described herein. For example, an electrolyte produced by the present teachings can be incorporated into solid oxide cells (SOCs) for use in energy conversion and storage applications. The electrolyte, characterized by nanoscale particle size and uniform elemental distribution, is sintered to achieve high density and phase purity. In an SOC, the electrolyte layer is positioned between an anode and a cathode. The resulting SOC can be utilized in a fuel cell stack for stationary power generation, or for portable power sources, or utilized in electrolysis cells for hydrogen production. The high proton conductivity and chemical stability of the electrolyte of the present teachings facilitate efficient operation, improving the overall performance and durability of the SOC devices.

In some embodiments, the electrolyte can be fabricated as a thin film using solution casting or thin film deposition techniques, and subsequently incorporated into micro-scale electrochemical devices. For example, the thin film electrolyte can be utilized in micro-SOCs for on-chip energy harvesting, sensors for environmental monitoring, or micro-reactors for chemical synthesis. The uniform elemental distribution and pure phase nature of the electrolyte contribute to reliable proton transport and reduced degradation over time, rendering the material appropriate for demanding microelectronic applications.

In certain embodiments, the electrolyte can be utilized in composite articles of manufacture, such as proton-conductive layers or other structure for fuel cells, sensors, or separation devices. Examples of articles of manufacture include, but are not limited to, electrochemical sensors for detecting gases or ions. The adaptability of the electrolyte enables customization for specific applications by modifying its composition, thickness, and integration method, thereby broadening its applicability across various energy and sensing technologies.

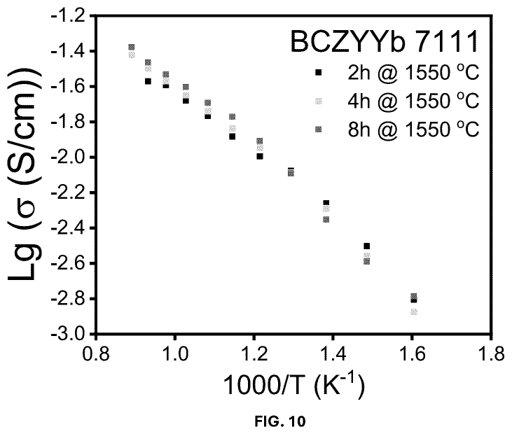

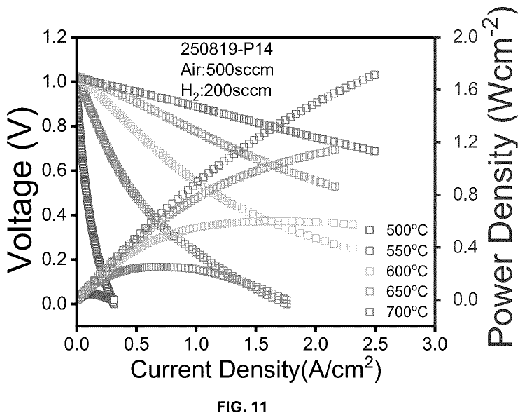

FIG. 10 is a graph of the results of the electrical conductivity evaluation of a BCZYYb7111 pellet. The pellet was sintered at 1550° C. under humidified nitrogen conditions, and the graph represents the logarithmic conductivity Lg(σ)Lg(σ) in Siemens per centimeter (S/cm) as a function of the reciprocal temperature 1000/T in inverse Kelvin (K′).

The graph includes data points corresponding to three distinct sintering durations at 1550° C.: 2 hours, 4 hours, and 8 hours. These durations are represented by black, green, and red markers, respectively. The data demonstrates the variation in protonic conductivity of the BCZYYb7111 pellet across a temperature range of 350° C. to 850° C.

The graph highlights the influence of sintering duration on the conductivity performance of the BCZYYb7111 pellet. Extended sintering times can contribute to improved densification and uniform elemental distribution of Ba, Ce, Zr, Y, and Yb, which play a significant role in enhancing proton transport pathways. The comparison of conductivity values for different sintering durations provides insights into the optimization of sintering conditions for achieving superior proton conductivity.

This evaluation highlights the importance of thermal treatment parameters, such as sintering temperature and duration, in adjusting the microstructure and phase purity of the BCZYYb7111 material, which directly influences the electrochemical performance of the material in applications like solid oxide cells.

FIG. 11 shows a fuel cell performance graph illustrating the relationship between current density, voltage, and power density across a range of operating temperatures from 500° C. to 700° C. The electrolyte utilized in the fuel cell is fabricated using the semi-batch method, which ensures precise control over the precursor material composition and subsequent phase formation. The fuel cell was operated under controlled conditions, with air supplied at a flow rate of 500 sccm and hydrogen at 200 sccm. These flow rates are optimized to maintain a steady supply of reactants to the electrodes, ensuring efficient electrochemical reactions. The data presented in FIG. 11 underscores the importance of temperature optimization in fuel cell operation, as well as the role of material synthesis methods in achieving high-performance proton-conducting electrolytes.

The graph can provide insights into the electrochemical behavior of the fuel cell under varying thermal conditions. The voltage curves demonstrate a clear dependence on temperature, with higher operating temperatures (e.g., 700° C.) yielding improved electrochemical performance, as evidenced by higher voltage values at equivalent current densities. This enhancement is attributed to the increased proton conductivity of the electrolyte at elevated temperatures, which facilitates efficient proton transport and reduces internal resistance.

The power density curves, plotted on the secondary axis, further highlight the performance improvements at higher temperatures. The peak power density increases significantly as the temperature rises, indicating that the fuel cell achieves optimal energy conversion efficiency at elevated thermal conditions. This behavior aligns with the thermal activation of proton transport mechanisms, such as the vehicle mechanism and Grotthuss mechanism, which are more effective at higher temperatures.

The semi-batch fabrication method employed for the electrolyte contributes to the uniform elemental distribution and phase purity, as described herein. These material properties play a significant role in minimizing elemental segregation and ensuring consistent proton conductivity across the electrolyte. The use of advanced synthesis techniques, such as calcination and sintering, further enhances the densification and structural integrity of the electrolyte, enabling stable performance across the temperature range.

### EXAMPLES

### Example 1. Preparation of BaCeₓZr_{0.8-x}Y_{0.1}Yb_{0.1}O₃ (BCZYYb)

The nitrate solutions, including barium nitrate, cerium nitrate, zirconyl nitrate, yttrium nitrate, and ytterbium nitrate are mixed in stoichiometric ratios with respect to the ratios in the targeted product. Nitric acid is added to the zirconyl nitrate solution to prevent precipitation in the metal oxide precursor solution. The concentration of the metal ions in the solution is controlled to be about 0.3×10⁻³ mol/g. The ammonium hydroxide and ammonium carbonate aqueous solution of 1.5×10⁻³ mol NH₄⁺/g is used as the precipitate reagent. One mole of barium ion requires one mole of ammonium carbonate. The ratio between hydroxide and carbonate follows the following chemical stoichiometric ratios for the precipitation application. One mole of ytterbium ion and yttrium ion requires three moles of ammonium hydroxide. One mole of cerium ion requires four moles of ammonium hydroxide. One mole of zirconyl ion requires two moles of ammonium hydroxide.

The precipitation reagent was then discharged to semi-batch reactor, and it was excessive by 50% to ensure complete precipitation. Then the metal precursor solution is slowly fed into the reactor. The reactor temperature was controlled at room temperature, and the ammonium hydroxide solution was stirred at 250 rpm. The feeding flow rate was controlled by peristaltic pump supplied by Fisher with a flow rate of 5 mL/min. After finishing the metal precursor, the stirring is continued for 30 minutes to complete precipitation. After the reaction is complete, the slurry was vacuum filtered and rinsed with deionized (“DI”) water for 3 times. The powder is then vacuum dried at 80° C. for 24 hours and followed by calcined at different temperatures for 10 hours in air.

The product is examined by XRD to confirm the purity of the phase and examined with SEM-EDS to confirm elemental uniformity and particle size.

The sintering ability of the electrolyte powder is evaluated by changing the sintering time at a specific temperature. The powder is mixed with 1 wt % p butyral (PVB). 1.5 g powder is pressed into a pellet of 20 mm diameter with a pressure of 5 metric tons with a uniaxial presser. The pellet is then buried into the same electrolyte powder and calcined at 1500° C.

Conductivity of the material is evaluated under 3% H₂O humidified nitrogen. Both side of the dense electrolyte pellet are painted with Pt electrode and sintered at 900° C. for 1 hour. The conductivity measurement is performed with a four probe homemade set-up with a Bio-Logic potentiostat. EIS is collected for each temperature to evaluate the resistivity and the conductivity in the bulk of the electrolyte.

Considering the above example, calcination at 900° C. for 10 hours can result in pure phase and uniform elemental distribution, compared with the SSR method which involves calcination at 1100° C. for 10 hours. In general, the present teachings can reduce the calcination temperature by 100˜200° C. and be completed in one calcination step compared to the conventional multi-step solid-state reaction method. Further, the electrolyte pellet with a thickness of about 1 mm can achieve over 95% of the theoretical density after sintering at 1500° C. for 4 hours. The electrical conductivity of the material is 0.13 S/cm at 600° C. which agrees with the literature reports.

### Example 2. Preparation of BaNbₓCe_{0.7}Yb₁₋ₓO₃ (BNCYb)

The nitrate solutions, including barium nitrate, cerium nitrate, and ytterbium nitrate are mixed in stoichiometric ratios with respect to the ratios in the targeted product. The precursor of niobium is selected as niobium oxalate. Niobium oxalate is dissolved in diluted nitric acid to form a clear solution and added to the metal precursor solution. The concentration of the metal ions in the solution is controlled at 0.3×10⁻³ mol/g. One mole of niobium ion requires five moles of ammonium hydroxide as the precipitation reagent.

### Example 3. Preparation of BaNbₓCe_{0.5-x}Gd_{0.2}O₃ (BNCGd)

The nitrate solutions, including barium nitrate, cerium nitrate, and gadolinium nitrate are mixed in stoichiometric ratios with respect to the ratios in the targeted product. The precursor of niobium is selected as niobium oxalate. The concentration of the metal ions in the solution is controlled at 0.3×10⁻³ mol/g. One mole of gadolinium ion requires 3 moles of ammonium hydroxide as the precipitation reagent.

### Example 4. Preparation of La₁₋ₓSrₓScO₃ (LSSc)

The nitrate solutions, including lanthanum nitrate, strontium nitrate, and scandium nitrate are mixed in stoichiometric ratios with respect to the ratios in the targeted product. The concentration of the metal ions in the solution is controlled at 0.3×10⁻³ mol/g. For the precipitation region formation, one mole of lanthanum ion and scandium ion require 3 moles of ammonium hydroxide as the precipitation reagent. One mole of strontium ion requires 2 moles of ammonium carbonate.

To facilitate an understanding of the present invention, a number of terms and phrases are defined below.

Unless defined otherwise, all technical and scientific terms used herein have the same meaning as commonly understood by one of ordinary skill in the art to which this invention belongs. The abbreviations used herein have their conventional meaning within the chemical and biological arts. The chemical structures and formulae set forth herein are constructed according to the standard rules of chemical valency known in the chemical arts.

The terms “a” and “an” as used herein mean “one or more” and include the plural unless the context is inappropriate.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular compound, that compound can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments can be variously combined or separated without parting from the present teachings and invention(s). For example, it will be appreciated that all features described and depicted herein can be applicable to all aspects of the invention(s) described and depicted herein.

In other words, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the disclosure herein of any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Accordingly, any means which can provide those functionalities can be regarded as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise.

As used herein, the term “about” refers to a ±10% variation, a ±5% variation, or a ±2.5% variation from the nominal value as understood from the context, unless otherwise indicated or inferred from the context.

At various places in the present specification, values are disclosed in groups or in ranges. It is specifically intended that the description include each and every individual sub-combination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present invention and does not pose a limitation on the scope of the invention unless claimed. The examples provided herein are intended solely for illustrative purposes and are not to be interpreted as restricting the disclosed subject matter to the specific embodiments presented. No language in the specification should be construed as indicating any non-claimed element as essential to the practice of the present invention.

Throughout the description, where compositions and kits are described as having, including, or comprising specific components, or where processes and methods are described as having, including, or comprising specific steps, it is contemplated that, additionally, there are compositions and kits of the present invention that consist essentially of, or consist of, the recited components, and that there are processes and methods according to the present invention that consist essentially of, or consist of, the recited processing steps.

As a general matter, compositions specifying a percentage are by weight unless otherwise specified.

Any particular embodiment of the present teachings that falls within the prior art can be explicitly excluded from any one or more of the claims. Because such embodiments are deemed to be known to one of ordinary skill in the art, they can be excluded even if the exclusion is not set forth explicitly herein. Any particular embodiment of the disclosure can be excluded from any claim, for any reason, whether or not related to the existence of prior art.

The disclosure can be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein.

What is claimed is:

1. A proton-conducting ceramic electrolyte comprising:
a sintered multi-metal oxide solid solution defined by grains that derive from pre-sintered precursor particulates having an average particle diameter from 1 nanometer to 20 nanometers, wherein the sintered multi-metal oxide solid solution exhibits a uniform elemental distribution across and within individual grains; wherein the individual grains comprise a single crystalline phase with minimal secondary phases detectable by x-ray diffraction.

2. The electrolyte of claim 1, wherein the sintered multi-metal oxide solid solution comprises at least two metal oxides selected from the group consisting of alkaline earth elements, transition elements, and lanthanide elements.

3. The electrolyte of claim 2, wherein a metal oxide of the sintered multi-metal oxide solid solution comprises one or more of barium oxide, cerium oxide, zirconium oxide, yttrium oxide, and ytterbium oxide.

4. The electrolyte of claim 2, wherein a metal oxide of the sintered multi-metal oxide solid solution comprises an oxide selected from the group consisting of scandium oxide, hafnium oxide, niobium oxide, tantalum oxide, calcium oxide, strontium oxide, praseodymium oxide, neodymium oxide, samarium oxide, europium oxide, gadolinium oxide, terbium oxide, dysprosium oxide, holmium oxide, erbium oxide, thulium oxide, or a combination thereof.

5. The electrolyte of claim 1, wherein the pre-sintered precursor particulates exhibit a uniform intraparticle spatial distribution of constituent metal cations.

6. The electrolyte of claim 1, wherein the grains exhibit a controlled microstructure characterized by reduced grain coarsening relative to electrolytes produced by solid-state reaction processing.

7. The electrolyte of claim 1, wherein the sintered multi-metal oxide solid solution has a perovskite structure of nominal formula ABO_{3-δ} in which A comprises at least one alkaline earth element and B comprises at least one of cerium, zirconium, and a lanthanide dopant, and 0<δ≤0.2.

8. The electrolyte of claim 7, wherein A comprises barium alone or in combination with strontium or calcium such that A is represented by Ba₁₋ₓAₓ with A selected from Ca and Sr and 0<x≤0.5.

9. The electrolyte of claim 7, wherein B in the nominal formula ABO_{3-δ} comprises a cerium-zirconium solid solution acceptor-doped with at least one lanthanide selected from yttrium, ytterbium, scandium, gadolinium, and neodymium in a total dopant fraction between 0.05 and 0.30 relative to B.

10. The electrolyte of claim 7, wherein the composition is represented by BaCe_{1-y-z}Zr_{y}M_{y}M′_{z}O_{3-δ}, where M and M′ are independently selected from Y, Yb, Sc, Gd, and Nd, 0.05≤(y+z)≤0.30, 0≤y≤0.30, 0≤z≤0.30, and 0<δ≤0.2.

11. The electrolyte of claim 7, wherein the A to B cation ratio is between 0.95 and 1.05 on a molar basis.

12. The electrolyte of claim 7, wherein zirconium content of B is between 0.05 and 0.40 on a molar basis.

13. The electrolyte of claim 7, wherein the lanthanide dopant content of B is between 0.08 and 0.20 on a molar basis.

14. The electrolyte of claim 7, wherein a molar ratio of cerium to zirconium is between 3:1 and 9:1.

15. A solid oxide cell comprising:
a proton-conducting ceramic electrolyte disposed between an anode and a cathode; wherein the proton-conducting ceramic electrolyte comprises:
a sintered multi-metal oxide solid solution defined by grains that derive from pre-sintered precursor particulates having an average particle diameter from 1 nanometer to 20 nanometers, wherein the sintered multi-metal oxide solid solution exhibits a uniform elemental distribution across and within individual grains; wherein the individual grains comprise a single crystalline phase with minimal secondary phases detectable by x-ray diffraction

16. The solid oxide cell of claim 15, wherein the proton-conducting ceramic electrolyte is a dense film having a thickness of 5 to 50 micrometers and a bulk density of at least 95 percent of theoretical.

17. The solid oxide cell of claim 15, wherein the solid oxide cell is configured to operate in a temperature range of 400° C. to 800° C.

18. The solid oxide cell of claim 15, wherein the anode and cathode are co-fired or co-sintered with the electrolyte to form an integrated cell structure, or are tape-cast or screen-printed onto a porous support to produce a dense electrolyte layer on a mechanically robust substrate.

19. An apparatus comprising: a plurality of solid oxide cells, each solid oxide cell comprising:
a proton-conducting ceramic electrolyte disposed between an anode and a cathode; the proton-conducting ceramic electrolyte comprising:
a sintered multi-metal oxide solid solution defined by grains that derive from pre-sintered precursor particulates having an average particle diameter from 1 nanometer to 20 nanometers, wherein the sintered multi-metal oxide solid solution exhibits a uniform elemental distribution across and within individual grains; where the individual grains comprise a single crystalline phase with minimal secondary phases detectable by x-ray diffraction;
where the plurality of solid oxide cells are in electrical communication in series or in parallel.

20. The apparatus of claim 19, further comprising power conditioning and control electronics configured to operate the plurality of solid oxide cells in fuel cell mode and in electrolysis mode.
